(19) United States
(12) Patent Application Publication
(10) Pub. No.: US 2019/0384419 A1
(43) Pub. Date: Dec. 19, 2019

(54) HANDHELD CONTROLLER, TRACKING METHOD AND SYSTEM USING THE SAME

(71) Applicant: GUANGDONG VIRTUAL REALITY TECHNOLOGY CO., LTD., SHENZHEN (CN)

(72) Inventors: WEI LI, SHENZHEN (CN); BISHENG RAO, SHENZHEN (CN); JINGWEN DAI, SHENZHEN (CN); JIE HE, SHENZHEN (CN)

(21) Appl. No.: 16/314,400

(22) PCT Filed: Aug. 16, 2017
(86) PCT No.: PCT/CN2017/097738

§ 371 Date: Dec. 29, 2018

(51) Int. Cl. G06F 3/0346; G06F 3/01; G06T 7/246; A63F 13/24; A63F 13/213

(52) U.S. Cl. CPC G06F 3/0346; G06F 3/011; A63F 13/213; A63F 13/24; G06T 7/246

(57) ABSTRACT

The disclosure discloses a handheld controller, a tracking method and a tracking system. The handheld controller can include a handle and a support. The handle can include an input device for detecting an input operation of a user. The support is coupled to the handle. The support can include an exterior surface with an identification pattern. In the tracking method, the imaging device captures an image of the identification pattern; the electronic device tracks and positions the handheld controller based on the identification pattern. In the disclosure, the handheld controller can be provided with the identification pattern. Such that tracking and positioning the handheld controller can be realized. It can avoid providing the light source and avoids controlling a frequency of the light source. Such that a structure of the handheld controller can be simplified, and costs can be reduced. In addition, there is no need to adjust parameters of the imaging device to track the controller with the light source, and an operation for controlling the imaging device can be simplified.

### TECHNICAL FIELD

The present disclosure relates to the field of computer entertainment. More particularly, and without limitation, the disclosed embodiments relate to a handheld controller, a tracking method and a system using the same.

### BACKGROUND

Interactive control technology is an important technology in the fields of virtual reality (VR)/augmented reality (AR)/mixed reality (MR). The interactive control technology can act a huge role in the development of VR/AR/MR. A handheld controller (handle) is employed in the field of VR/AR/MR to achieve an interactive control. The handheld controller provides a strong support for the interactive control. User can realize a human-computer interaction function by operating buttons (such as buttons, triggers, touchpads, etc.) of the handheld controller.

In order to improve user experience in virtual reality, currently optical methods may be applied for tracking and positioning the handheld controller, for example infrared or a light spot can be applied to the handheld controller for tracking and positioning the handheld controller. However, a special equipment is required when the handheld controller is tracked and positioned via an infrared tracking method. It can result a delay when the handheld controller is tracked and positioned by adding a light spot, a complete frequency cycle is required to identify the light spot, and a strobe frequency of the light spot needs to be precisely controlled.

### SUMMARY

Embodiments of the present disclosure provide a handheld controller, a tracking method and a system to solve the above problem.

In a first aspect, an alignment method is provided. The handheld controller, including: a handle having an input device for detecting an input operation of a user; a support coupled to the handle; the support including an exterior surface; and an identification pattern disposed on the exterior surface.

According to some embodiments in the present disclosure, the support is annular.

According to some embodiments in the present disclosure, the handle includes a first end and a second end opposite to the first end. The first end is coupled to the support, and the second end is far away from the support.

According to some embodiments in the present disclosure, the input device is disposed at the second end; the handle is configured to detect the input operation via the input device when a hand of user passes through the support and holds the handle.

According to some embodiments in the present disclosure, the handle is inclined relative to a plane along which the support is disposed.

According to some embodiments in the present disclosure, the support further includes an interior surface; the handle is disposed in a space defined by the interior surface.

According to some embodiments in the present disclosure, the input device is disposed at the first end; the handle is configured to detect the input operation via the input device when a hand of user is outside the support and holds the handle.

According to some embodiments in the present disclosure, the support defines an opening; the handle is coupled to an end of the support adjacent to the opening; the handle is configured to detect the input operation via the input device when a hand of user passes the opening and holds the handle.

According to some embodiments in the present disclosure, the exterior surface of the support comprises a first surface and a second surface; the first surface and the second surface intersect with each other at a circumscribed circle of the support; the identification pattern is disposed on at least one of the first surface and the second surface.

According to some embodiments in the present disclosure, the identification pattern is disposed on both of the first surface and the second surface; the identification pattern on the first surface and the identification pattern on the second surface are different from each other.

According to some embodiments in the present disclosure, the exterior surface is an arc surface; the identification pattern is disposed on the arc surface.

According to some embodiments in the present disclosure, the exterior surface includes a plurality of plates in different shapes, and the plates are spliced together to form the exterior surface; each of the plates provides a pattern thereon; patterns of all the plates corporately form the identification pattern.

According to some embodiments in the present disclosure, the plates include hexagonal plates, pentagonal plates, triangular plates, or trapezoidal plates.

According to some embodiments in the present disclosure, the identification pattern includes a background and a feature point distributed on the background; brightness of the background and brightness of the feature point are different so that an imaging device is capable of distinguishing the background and the feature point.

According to some embodiments in the present disclosure, all the feature points have the same size and all the feature points are evenly distributed on the background.

According to some embodiments in the present disclosure, the feature points may include a plurality of first feature points and a plurality of second feature points; the first feature points are larger than the second feature points; the first feature points and the second feature points are distributed on the background alternately.

According to some embodiments in the present disclosure, the feature point is circular, polygonal or rectangular.

According to some embodiments in the present disclosure, the background is black, and the feature point is white; or the background is white and the feature point is black.

In a second aspect, an alignment method is provided. The handheld controller, including: a handle having an input device for detecting an input operation of a user; a support coupled to the handle; the support including an exterior surface; an identification pattern disposed on the exterior surface; and a microcontroller coupled to the input device; wherein the microcontroller is configured to receive and process data or signals from the input device; the microcontroller is disposed in the handle or the support.

In a third aspect, an alignment method is provided. The tracking system, including: an electronic device; an imaging device; and a handheld controller as mentioned above, wherein the imaging device is configured to identify the identification pattern.

In a fourth aspect, an alignment method is provided. The tracking method applied in a tracking system; the tracking system including an electronic device, an imaging device, and a handheld controller; the handheld controller including a handle and a support coupled to the handle; the handle comprising an input device for detecting an input operation of a user; an exterior surface of the support has an identification pattern; and the method can comprising: capturing an image of the identification pattern via the imaging device; positioning and tracking the handheld controller via the electronic device based on the identification pattern.

According to some embodiments in the present disclosure, the handheld controller includes a sensor for detecting an attitude data. Positioning and tracking the handheld controller based on the identification pattern via the electronic device, includes:

positioning and tracking the handheld controller via the electronic device based on the identification pattern and the attitude data obtained by the sensor.

In some embodiments, positioning and tracking the handheld controller based on the identification pattern via the electronic device, includes: determining a position and an orientation of a specific point of the handheld controller relative to the imaging device by identifying feature points of the identification pattern and based on a three-dimensional (3D) structure information of the feature points; and

positioning and tracking the handheld controller via the electronic device based on the position and the orientation.

In the embodiment of the present disclosure, the handheld controller can be provided with the identification pattern. Such that tracking and positioning the handheld controller can be realized. Thereby a handheld controller with a light source can be replaced, which avoids providing the light source and avoids controlling a frequency of the light source. Such that a structure of the handheld controller can be simplified, and costs can be reduced. In addition, there is no need to adjust parameters of the imaging device to track the controller with the light source, and an operation for controlling the imaging device can be simplified.

### BRIEF DESCRIPTION OF THE DRAWINGS

FIG. 1 illustrates a schematic view of a tracking system, in accordance with an embodiment of the present disclosure.

FIG. 2 illustrates a schematic view of an electronic device, in accordance with an embodiment of the present disclosure.

FIG. 3 illustrates a schematic view of a handheld controller, in accordance with an embodiment of the present disclosure.

FIG. 4A to FIG. 4D illustrate exemplary schematic views of identification pattern for tracking, in accordance with an embodiment of the present disclosure.

FIG. 5 illustrates an exemplary schematic view of another identification pattern for tracking, in accordance with by an embodiment of the present disclosure.

FIG. 6 illustrates an exemplary schematic diagram of still another identification pattern for tracking, in accordance with an embodiment of the present disclosure.

FIG. 7 illustrates a schematic view of the handheld controller of FIG. 3 when in use, in accordance with an embodiment of the present disclosure.

FIG. 8 illustrates a schematic view of the handheld controller of FIG. 3 when in use, which is taken from another perspective, in accordance with an embodiment of the present disclosure.

FIG. 9 illustrates a schematic view of a handheld controller, in accordance with another embodiment of the present disclosure.

FIG. 10 illustrates a schematic view of the handheld controller of FIG. 9 when in use.

FIG. 11 illustrates a schematic view of a handheld controller, in accordance with still another embodiment of the present disclosure.

FIG. 12 illustrates a schematic view of the handheld controller of FIG. 11 when in use.

FIG. 13 illustrates a schematic view of function blocks of a handheld controller, in accordance with an embodiment of the present disclosure.

FIG. 14 illustrates a schematic flowchart of a tracking method, in accordance with an embodiment of the present disclosure.

### DETAILED DESCRIPTION OF EMBODIMENTS

The technical solutions in the embodiments of the present disclosure are clearly and completely described in the following with reference to the accompanying drawings in the embodiments of the present disclosure. It is a partial embodiment of the disclosure, and not all of the embodiments. The components of the embodiments of the disclosure, which are generally described and illustrated in the drawings herein, may be arranged and designed in various different configurations.

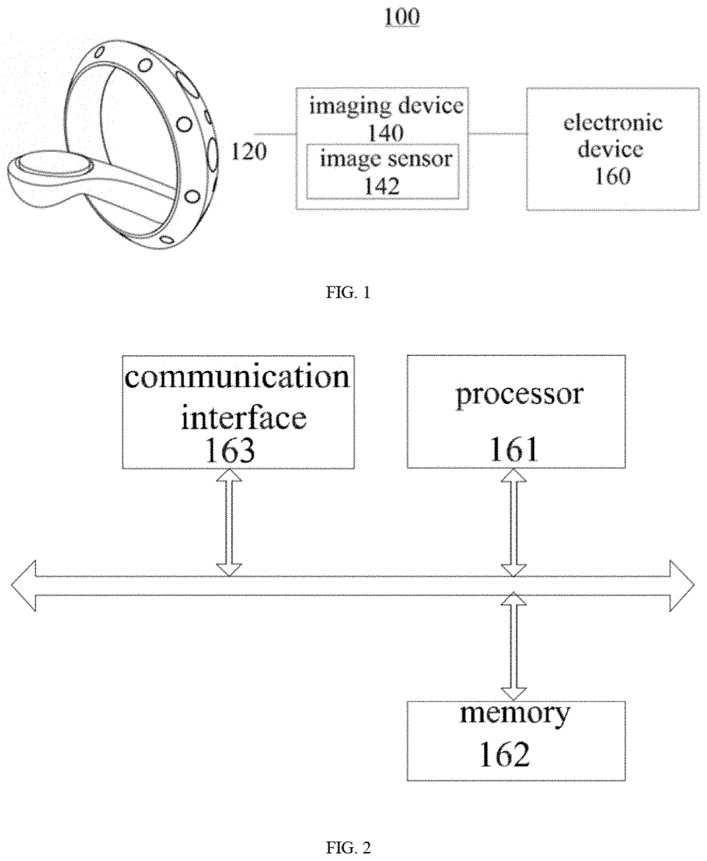

FIG. 1 illustrates a schematic view of a function block of a tracking system, in accordance with an embodiment of the present disclosure. As illustrated in FIG. 1, in some embodiments, the tracking system 100 can include a handheld controller 120, an imaging device 140 with an image sensor 142, and an electronic device 160.

An exterior surface of the handheld controller 120 provides an identification pattern. The imaging device 140 can be configured to capture an image of the handheld controller 120 including the identification pattern. The identification pattern can include a background and at least one feature point distributed on the background in a preset manner. The color of the background and the color of the feature point can be different from each other, so as to the background and the feature point can be distinguished by the imaging device 140. In some embodiments, the brightness of the background and the brightness of the feature point can be different from each other so as the background and the feature point can be distinguished by the imaging device 140. For example, the background is black, the feature point is white, or the background is white while the feature point is black. The electronic device 160 can be configured to identify and track the handheld controller 120 based on the image captured by the imaging device 140, wherein the image can include the identification pattern of the handheld controller 120.

Compared with an existing solution, the tracking system of the embodiment of the present disclosure can identify and track the handheld controller based on the identification pattern of the handheld controller. Thereby a handheld controller with a light source can be replaced, which avoids providing the light source and avoids controlling a frequency of the light source. Such that a structure of the handheld controller can be simplified, and costs can be reduced. In addition, there is no need to adjust parameters of the imaging device to track the controller with the light source, and an operation for controlling the imaging device can be simplified.

The imaging device 140 can be any device capable of capturing an image of an object located in a field of view (FOV) of the imaging device 140. In some embodiments, the imaging device 140 may not be positioned at a stable location, for example, the imaging device 140 may be worn by a user (e.g., the imaging device 140 can be worn on user's head and can be considered as a portion of a headset), and moved following a movement of user, the device 140 may be disposed on the headset as shown in FIG. 1. In some embodiments, the imaging device 140 can be mounted at a stable location, for example, it can be positioned on a table or a support. The imaging device 140 can be configured to capture images of objects at different locations in the FOV of imaging device 140.

The imaging device 140 can include an image sensor 142. The image sensor 142 may be a Complementary Metal Oxide Semiconductor (CMOS) sensor, a Charge-coupled Device (CCD) sensor, or the like.

In some embodiments, the imaging device 140 can be configured to capture multiple images at different times during a period of time, for example, when the handheld controller 120 is moved in the FOV of the imaging device 140, the imaging device 140 can capture multiple images of the handheld controller 120 at different locations during the period of time. The imaging device 140 can be further configured to obtain a time information when capturing each of the images. The imaging device 140 may also configured to transmit the time information and the images to the electronic device 160 for further processing. In an example embodiment of the disclosure, the electronic device 160 may be configured to position and track the handheld controller 120 by identifying the identification pattern in the image.

In some embodiments, the imaging device 140 may further include a position sensor (not shown) for determining a position of the imaging device 140. The imaging device 140 may be further configured to transmit the position to the electronic device 160. For example, the imaging device 140 may include a global positioning system (GPS) configured to transmit a position coordinate data to the electronic device 160.

As illustrated in FIG. 1, the imaging device 140 can be configured to communicate with the electronic device 160 and transmit an image data to the electronic device 160. The imaging device 140 may be further configured to receive a command from the electronic device 160, wherein the command is configured to determine parameters for capturing an image. Exemplary parameters therein for capturing the image may include time of exposure, aperture, image resolution/size, FOV (e.g., zooming in and out), and/or color space of the image (e.g., color mode or black and white mode) and/or parameters configured to perform other types of known functions of the imaging device or a camera. The imaging device 140 and the handheld controller 120 can be coupled to each other via a network connection, a bus, or other type of data link (e.g., wire connection, wireless connection (e.g., Bluetooth™) or other connection known in the art).

The electronic device 160 can be a computing device, such as a computer or notebook computer, a mobile terminal, a tablet, a smart phone, a wearable device (such as a headset), a gaming machine, or any combination of these computers and/or accessory components.

The electronic device 160 can be configured to receive and process data/signals from other components of the tracking system. For example, as disclosed in the present disclosure, the electronic device 160 can configured to receive and process the image data from the imaging device 140 and/or an input data from the handheld controller 120. The electronic device 160 may be further configured to transmit data/signals to other components of the tracking system. Other components may perform certain functions based on data/signals from electronic device 160.

As illustrated in FIG. 2, in some embodiments, the electronic device 160 can include a processor 161, a memory 162, and a communication interface 163.

The processor 161 can include any suitable type of microprocessor having general purpose or special purpose, digital signal processor or microcontroller. The processor 161 can be configured to position and track an object as a separate processor module. Alternatively, the processor 161 can be configured to perform other functions as a shared processor module which is unrelated to positioning or tracking objects. The processor 161 can be configured to receive data and/or signals from various components of the tracking system via, for example, a network. The processor 161 can be further configured to determine one or more operating conditions in the tracking system by processing data and/or signals. For example, the processor 161 can be configured to receive an image from the imaging device 140 and determine whether the image include the identification pattern. The processor 161 can be further configured to identify the feature point in the identification pattern. Additionally, or alternatively, the processor 161 can be configured to determine a size and an amount of the feature points in the identification pattern. The processor 161 can be further configured to identify a target object based on the size of the feature points and/or the number of the feature points.

The memory 162 can include any suitable type of memory having mass storage for storing any type of information on which the processor may need to process. The memory can be volatile or nonvolatile, magnetic, semiconductor, magnetic, optical, erasable, non-erasable or other type of storage device or tangible (i.e., non-transitory) computer readable medium. The memory can include but not limited to ROM, flash memory, dynamic RAM and static RAM. The memory 162 can be configured to store one or more programs for positioning and tracking the target objects, wherein the programs can be executed by the processor 161 as disclosed in the present disclosure.

The memory 162 can be further configured to store information and data processed by the processor 161. For example, the memory 162 can be configured to store a lookup table that can include the identification pattern and their corresponding data. The processor 161 can be configured to determine an identity of the identification pattern by querying the lookup table when the identification pattern is distinguished.

The communication interface 163 can be configured to facilitate a communication between the controller and other components of the tracking system via, for example a network. For example, the electronic device 160 can receive the input data/signals from the handheld controller via the communication interface 163 to control characters in a game. The electronic device 160 can be further configured to transmit data/signals to other displays for presenting games (images, video and/or sound signals) via the communication interface 163.

The network may include or partially include any one or more of various networks or other types of communication connections known to those skilled in the art. The network may include network connections, buses or other types of data links, such as hardwired or other connections known in the art. For example, the network may include: The Internet, an intranet, a local area network or other wireless or other hardwired connection, or other means of connection (e.g., Bluetooth, Wi-Fi, 4G LTE cellular data network, etc.) through which the components of the tracking system can achieve communication function.

The electronic device 160 can be provided with a display device. In some embodiments, the display device can be a portion of an electronic device 160 (e.g., a display device in a headset, a screen of a laptop, etc.). In some embodiments, the display device may be a displayer (e.g., LED, OLED or LCD) or the like separate from a stand-alone standard television, HDTV, digital television, or any type of electronic device 160 (e.g., a gaming console).

The handheld controller 120 can be in communication with the electronic device 160, user can hold the controller in one or both hands typically, and operate the input keys or the like on the handheld controller 120 easily. When playing a game or performing a virtual reality event, user can interact with one or more characters in the game, for example, the handheld controller 120 can detect an input operation from user and transmit an input signal/data to the electronic device 160 based on the input operation, the electronic device 160 can process the input signal/data and/or change the game based on the input signal/data. In some embodiments, the handheld controller 120 can be configured to receive data/signals from the electronic device 160 for controlling components of the handheld controller 120. For example, the electronic device 160 can transmit an interaction request or the like, and the handheld controller 120 can receive the interaction request and transmit a corresponding feedback, for example, user can control the headset to active a function via the eyes thereof, and the headset can transmit a corresponding request signal to the handheld controller 120, the handheld controller 120 vibrates when receiving the corresponding request signal, so as to alert user to begin operation.

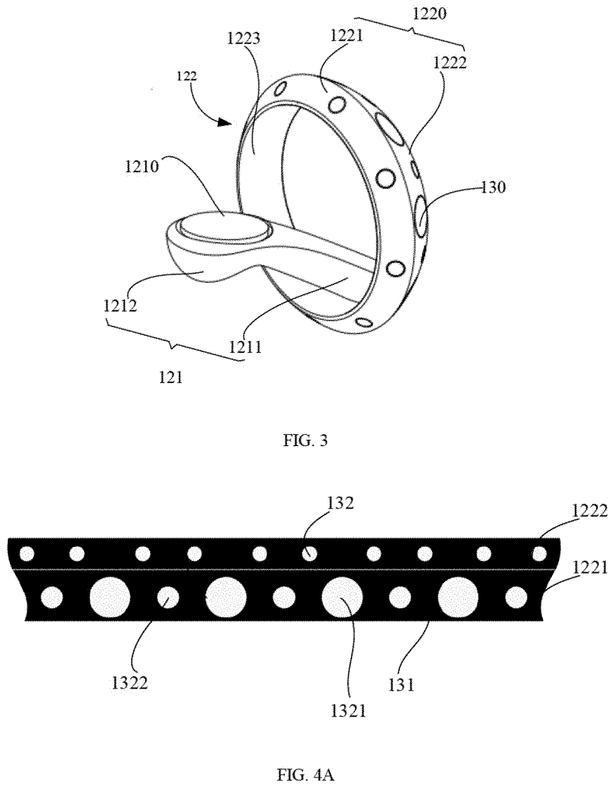

FIG. 3 illustrates a structure of the handheld controller 120, in accordance to some embodiments of present disclosure. The handheld controller 120 may include a handle 121 and a support 122. The handle 121 can be coupled to the support 122. The identification pattern is formed on an exterior surface of the support 122.

The handle 121 can include an input device 1210. The input device 1210 can be configured to generate an input data in response to an input operation of user. Exemplary input operations of user may include a touch input, a gesture input (e.g., hand waving, etc.), keystrokes, forces, sounds, voice conversations, a facial recognition, fingerprints, or the like, and any combinations thereof. The input device 1210 can include a plurality of buttons, joysticks, a touchpad, a keyboard, an imaging sensor, an acoustic sensor (e.g., a microphone), a pressure sensor, a motion sensor or a finger texture/palm scanner, or the like, and any combinations thereof. As illustrated in FIG. 3, the input device 1210 can include a thumb button. In some embodiments, the input device 1210 may also include a plurality of buttons, for example, a main button and other buttons, wherein the main button may be positioned remotely from other buttons to prevent erroneous operation. In some embodiments, the input device 1210 can include a touch-sensitive surface that is divided into multiple portions, wherein each of the portions is corresponding to an input key. In this configuration, at least one touch sensor is positioned below a surface of the input device 1210. An action associated with the corresponding input key is performed when a touching operation of user is detected by the touch sensor.

The input data can be generated when user is operating on the input device 1210. The button, the touch sensor, or the like of the input device 1210 is configured to communicate with the electronic device 160 to convert the input operation into a corresponding action or a demand.

In some embodiments, the handle 121 can be a protruding structure of the handheld controller 120. The handle 121 may have a rod-shaped, for example, may be a flat cylindrical shape, or other structure that allows user to hold via the palm and the finger (e.g., three or fewer fingers) thereof, while the thumb of user can be released for operating the input keys, and as well as other fingers can be released to operate on a corresponding portion corresponding to the other fingers.

The handle 121 can include a first end 1211 and a second end 1212 opposite to the first end 1211. In some embodiments, the first end 1211 can be coupled to the support 122. The second end 1212 can be far away from the support 122. In some embodiments, the handle 121 is detachably coupled to the support 122. The handle 121 can be attached to the support 122 by a connection manner corresponding to a material thereof, for example, the handle 121 can be attached to the support 122 to the support 122 by bonding or welding. Alternatively, the handle 121 and the support 122 may be connected to each other via a fastening structure such as via a screw or a bolt, or may be engaged with each other via a snap or the like, or may be slidably connected via a sliding groove and a protrusion. A detachable connection between the handle 121 and the support 122 allows the handle 121 and the support 122 to be manufactured separately, and it is also convenient to replace the components when damaged, thereby the maintenance costs can be reduced. In some embodiments, the handle 121 can be further configured to be integrally formed with the support 122.

In some embodiments, the handle 121 and/or the support 122 may be made from a rubber material (e.g., to provide a surface that is sufficiently rubbed with the palm of user, thereby increasing a reliability of when the handheld controller 100 is held). In some embodiments, the handle 121 and/or the support 122 can be made from a hard plastic including, but not limited to, a high-density polyethylene that provides a high structural rigidity. In addition, any other suitable material can be used to manufacture the handle 121 and/or the support 122.

In some embodiments, the support 122 may be annular or elliptical in shape, and may be a closed ring or a ring having an opening. The support 122 can include an exterior surface 1220 that faces an outer space of the ring and an interior surface 1223 that faces an inner space of the ring. The exterior surface 1220 can include a first surface 1221 and a second surface 1222. The first surface 1221 and the second surface 1222 can intersect with each other at a circumscribed circle of the support 122. The interior surface 1223 can be coupled to the first surface 1221 and the second surface 1222. The identification pattern 130 can be disposed on at least one of the first surface 1221 and the second surface 1222. The identification pattern 130 may be formed on the exterior surface 1220 by drawing or spraying. In some embodiments, the identification pattern 130 may be attached to the exterior surface 1220 as a pattern layer. In some embodiments, other manners may be employed when the identification pattern 130 is formed or provided, and there is not limited herein.

In some embodiments, both of the first surface 1221 and the second surface 1222 can be provided with the identification patterns 130. The identification pattern 130 on the first surface 1221 may be different from the identification pattern 130 on the second surface 1222. Furthermore, an area of the second surface 1222 may be greater than an area of the first surface 1221. The second surface 1222 having a greater area is disposed toward the imaging device 140, such that the imaging device 140 can easily determine and identify the identification pattern 130 on the second surface 1222.

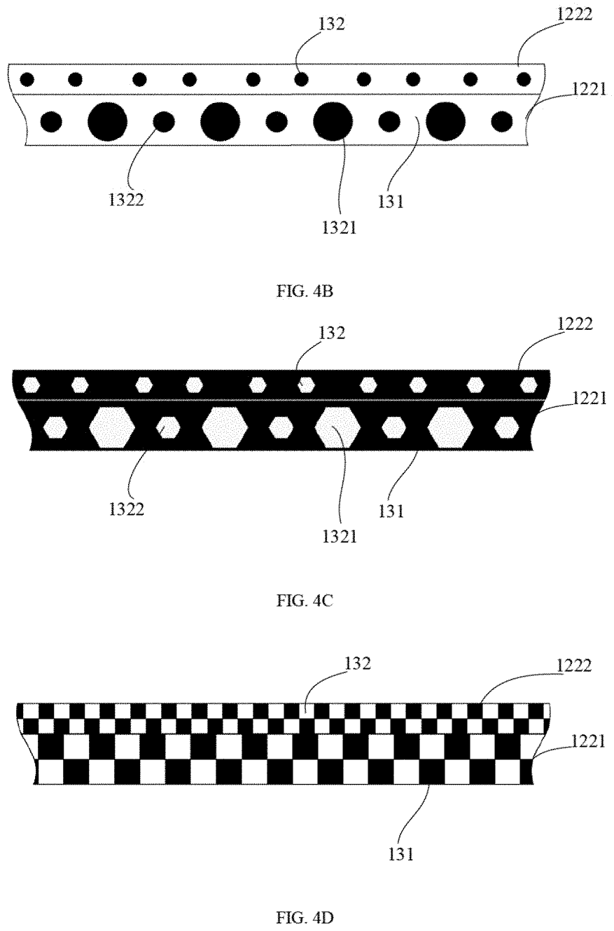

FIG. 4A to FIG. 4D are exemplary schematic views of several identification patterns 130 after the exterior surface 1220 is unfolded. As illustrated in FIG. 4A to FIG. 4D, the identification pattern 130 can include a background 131 and at least one feature point 132 distributed on the background 131. The color of the background 131 and the color of the feature point 132 can be different from each other, so as to be distinguished by the imaging device 140. In some embodiments, the brightness of the background 131 and the brightness of the feature point 132 can be different from each other so as they can be distinguished by the imaging device 140, for example, the background 131 is black, the feature point 132 is white, or the background 131 is white while the feature point 132 is black. In some embodiments, other color combinations may be employed, for example, the background 131 is gray while the feature point 132 is red. As long as the imaging device 140 can distinguished the background 131 and the feature point 132 by differentiating the colors or the brightness of the background 131 and the feature point 132. In some embodiment, a shape of the feature point 132 may be a circle, a polygon (for example, a hexagon), a rectangular, or any other shape. The shapes of all the feature points 132 in the same identification pattern 130 may be the same or different.

In some embodiments, the feature points 132 may have a same size. Furthermore, the feature points 123 may be evenly or periodically distributed along a circumference of the exterior surface 1220 on the background 131 and form a feature point strip, as illustrated in an upper portion of FIG. 4A to FIG. 4D. The identification patterns 130 on the first surface 1221 and the identification patterns 130 on the second surface 1222 may all be formed as the feature point strip mentioned above, except that the feature point 132 on the first surface 1221 and the feature point 132 on the second surface 1222 are different in size, as illustrated in FIG. 4D. In some embodiments, such as, but not limited to, the first surface 1221 can have a larger area, a size of the feature point 132 on the first surface 1221 are larger than that of the feature point 132 on the second surface 1222.

In some embodiments, the feature points 132 may be different in size. For example, the feature points 132 may include a plurality of first feature points 1321 and a plurality of second feature points 1322. The first feature point 1321 can be larger than the second feature point 1322. The first feature points 1321 and the second feature points 1322 are arranged alternately in size. The first feature points 1321 and the second feature points 1322 are distributed on the background 131 to form a feature point strip having an order of a first feature point 1321, a second feature point 1322, a first feature point 1321, a second feature point 1322, . . . . In some embodiments, the identification pattern 130 on the first surface 1221 and the second surface 1222 may be formed as the feature point strip mentioned above, the first feature points 1321 on the first surface 1221 are larger than the first feature point 1321 on the second surface 1222. The second feature point 1322 on the first surface 1221 is larger than the second feature point 1322 on the second surface 1222. Such a pattern may also be provided on only one of the first surface 1221 and the second surface 1222, such as on the first surface 1221, as illustrated in FIG. 4A to FIG. 4C.

As illustrated in FIG. 4A, the background of the identification pattern on the first surface 1221 and the second surface 1222 is black while the feature points are white. The feature points 132 positioned on the first surface 1221 can include a plurality of first feature points 1321 and a plurality of second feature points 1322. The first feature point 1321 and the second feature point 1322 are both circular, and the first feature point 1321 is larger than the second feature point 1322. In one embodiment, the first feature point 1321 and the second feature point 1322 on the first surface 1221 can be arranged in one or more rows alternately along a direction in which the strip extends. The first feature point 1321 and the second feature point 1322 on the second surface 1222 can be arranged in one or more rows alternately along the direction in which the strip extends.

As illustrated in FIG. 4B, the identification pattern of FIG. 4B is substantially identical to the identification pattern of FIG. 4A, except that the color of the background and the color of the feature point of FIG. 4B are opposite to those of FIG. 4A.

As illustrated in FIG. 4C, the identification pattern is substantially identical to the identification pattern of FIG. 4A, except that the feature points are not circular but hexagonal.

As illustrated in FIG. 4D, the identification patterns on the first surface 1221 and on the second surface 1222 can include multiple black blocks and white blocks. Two of the black blocks and two of white blocks are alternately arranges in a 2*2 matrix. All the black blocks and the white blocks are arranged in multiple matrixes and the matrixes are disposed in one or more rows on the first surface 1221 and the second surface 1222. The black block and the white block on the first surface 1221 are respectively larger than the black block and the white block on the second surface 1222.

In some embodiments, the identification patterns illustrated in FIG. 4A to FIG. 4D are merely exemplary patterns. The colors and the size of the feature points may be changed, and the specific implementation of the present disclosure is not limited. For example, the feature points on the first surface 1221 can be circle, and the feature points on the second surface 1222 can include black and white blocks arranged in one or more rows alternately.

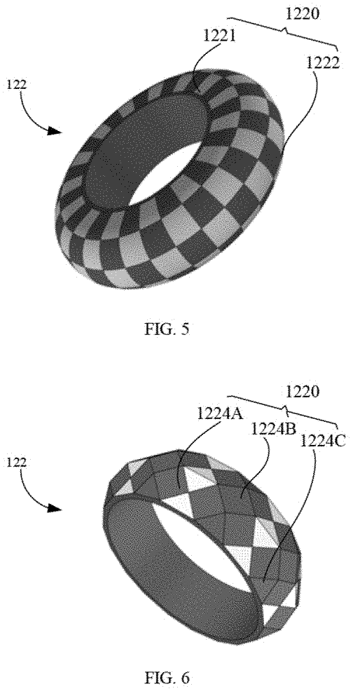

In some embodiments, a structure of the exterior surface 1220 of the support 122 is not limited to the structure of the first surface 1221 and the second surface 122 illustrated in FIG. 4A to FIG. 4D. In some embodiments, the first surface 1221 combining with the second surface 1222 can be a complete arc surface, as illustrated in FIG. 5.

FIG. 5 illustrates a schematic view of the support 122, in accordance with another embodiment in the present disclosure. In one embodiment, the exterior surface 1220 of the support 122 can be a curved surface. The first surface 1221 and the second surface 1222 can corporately form the curved surface. In some embodiments, the feature points on the first surface 1221 can be black and white blocks alternately arranged, or can be black and gray blocks alternately arranged. The feature points on the second surface 1222 can be black and white blocks alternately arranged, or can be black and gray blocks alternately arranged. In some embodiments, the size or arrangement manner of the black and white blocks or the black and gray blocks on the first surface 1221 and those on the second surface 1222 may be the same or different, and there is no limit.

As illustrated in FIG. 6, in some embodiments, the exterior surface 1220 may also include multiple plates of different shapes, wherein each of the plates can be provided with a pattern thereon. The plates can include hexagonal plates, pentagonal plates, triangular plates, and/or trapezoidal plates. In the embodiment illustrated in FIG. 6, the exterior surface 1220 of the support 122 includes hexagonal plates 1224A, quadrilateral plates 1224B, and triangular plates 1224C. The hexagonal plates 1224A, the quadrilateral plates 1224B, and the triangular plates 1224C are spliced to form the exterior surface 1220. Each of the hexagonal panel 1224A is provided with a pattern having black and white rectangular blocks or triangular blocks. In some embodiments, the patterns having the same color can be arranged continuously or in an alternately arrangement. As illustrated in FIG. 6, the quadrilateral plates 1224B and the triangular plates 1224C can be black. In some embodiments, the quadrilateral plates 1224B and the triangular plates 1224C can be white. In some embodiments, the identification pattern can be further configured to be other two colors or brightness so as to be distinguished by the imaging device 140, such as silver and black.

The imaging device 140 can be configured to detect a movement of the support 122 when user is moving (e.g., swinging, punching, shaking, or any other movements). In some embodiments, when user holds the handle 121 in a neutral manner, the support 122 is positioned at a location above user's hand. In this orientation, the identification pattern 130 on the first surface 1221 can be detected by the imaging device 140 (for example, the imaging device 140 may be a front view camera on a headset). Alternatively, the imaging device 140 can be positioned in front of user. When user holds the handle 121 in the neutral manner, the identification pattern 130 on the first surface 1221 can face the imaging device 140. The neutral manner can refer to a pose of the handle 121 held between the palm and the finger of user, and the handheld controller 120 is maintained in front of user, and which allows user to relax the arm and wrist thereof.

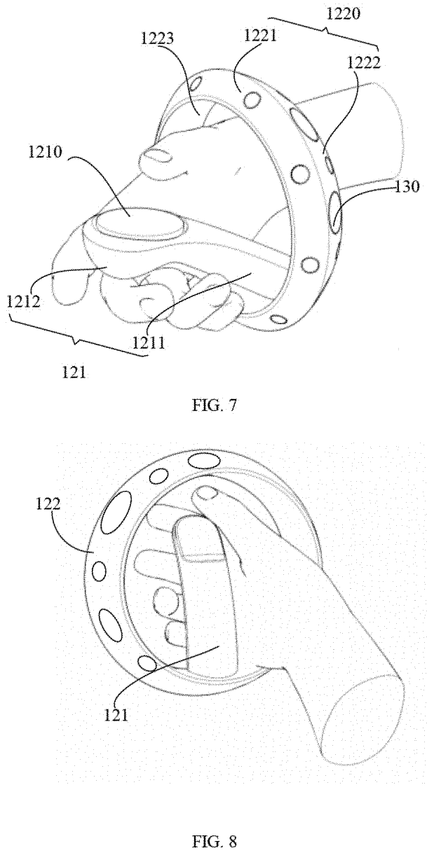

In some embodiments, as illustrated in FIG. 7, the input device 1210 of the handle 121 is disposed at the second end 1212. The handle 121 is configured to detect an input operation of user via the input device 1210 when user grips the handle 121 through the support 12.

The handle 121 can be inclined about a preset angle relative to a plane along which the support 122 is disposed, such that user can operate with a comfortable posture to hold the handle 121 and operate on the input device 1210. The preset angle may range from 30 degrees to 90 degrees, such as 45 degrees, 60 degrees, 75 degree. The input device 1210 can face the support 122.

As illustrated in FIG. 8, in some embodiments, the handle 121 is disposed in a space defined by the interior surface 1213 of the support 122. When user holds the handle 121 in the neutral manner, the support 122 is positioned in an orientation such that the hand of user is disposed over a center of the support 122 when user holds the handle 121.

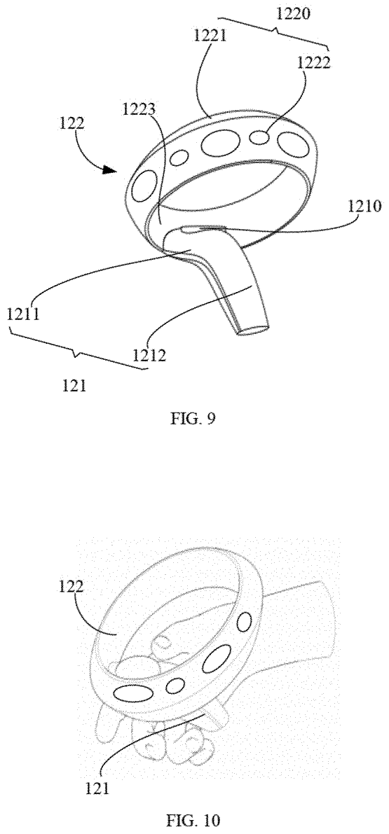

In some embodiments, as illustrated in FIG. 9, the input device 1210 of the handle 121 can be disposed at the first end 1211. The input device 1210 can be adjacent to a connection portion between the first end 1211 and the support 1212. The handle 121 is configured to be operated by user when the hand of user does not insert into or pass through the support 122, such that user can directly holds the handle 121 outside the support 122 and operate on the input device 1210 as illustrated in FIG. 10.

In the illustrated embodiment, the handle 121 can be inclined at a preset angle relative to a plane along which the support 122 is located. Such that user can hold the handle and operate on the input device 121 with a comfortable posture. When user holds the handle 121 in the neutral manner, the support 122 is positioned in an orientation such that the hand of user is disposed below the support 122 when user holds the handle 121.

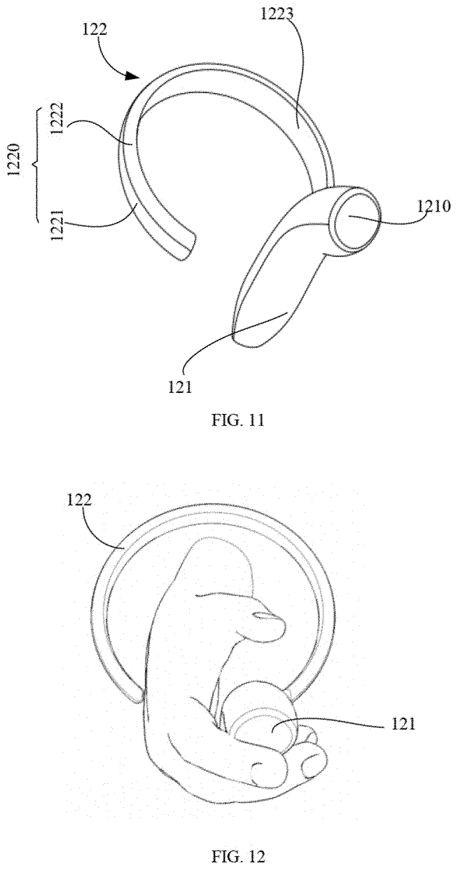

In some embodiments, as illustrated in FIG. 11, the support 122 can define an opening. The handle 121 can be coupled to an end of the support 122 which is adjacent to the opening. For example, the end of the support 122 can be coupled to a middle portion of the handle 121. The input device 1210 of the handle 121 can be disposed at the first end 1211. User can hold the handle 122 through the support 122 and perform an input operation via the input device 1210, as illustrated in FIG. 12.

In the illustrated embodiment, the handle 121 can be disposed substantially perpendicular to the plane along which the support 122 is located, such that user can hold the handle and operate on the input device 121 with a comfortable posture. When user holds the handle 121 in the neutral manner, the support 122 is positioned in an orientation such that the wrist of user can be disposed in the center of the support 122 and the palm of user can partially pass through the opening when user holds the handle 121.

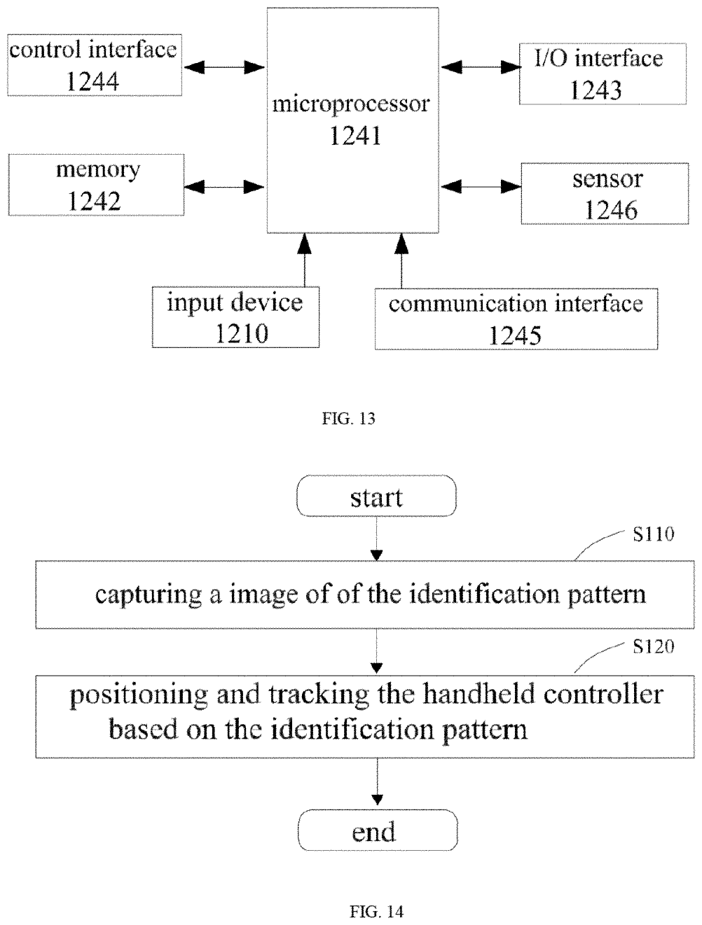

As illustrated in FIG. 13, FIG. 13 illustrates a schematic view of function blocks of the handheld controller 120. The handheld controller 120 can include the input device 1210 and a microcontroller 124 coupled to the input device 1210. The input device 1210 can include multiple buttons, joysticks, touch pads, keyboards, imaging sensors, sound sensors (e.g., microphones), pressure sensors, motion sensors or finger texture/palm scanners, and any combinations thereof.

In some embodiments, the handheld controller 120 can further include a microcontroller 124. The microcontroller 124 can be configured to receive and process data/signals from input device 1210 and/or other components of the tracking system. For example, the microcontroller 124 can be configured to receive an input data generated by the input device 1210 in response to an action and/or an input operation of user.

The microcontroller 124 can be further configured to generate the input data based on the input operation of user, and transmit the input data to the electronic device 160 for further processing. In some embodiments, the microcontroller 124 can be configured to generate control signals for controlling other components of the tracking system. For example, the microcontroller 124 can be configured to generate control signals for controlling the imaging device 140.

The microcontroller 124 can include a microprocessor 1241, a memory 1242, an I/O interface 1243, a control interface 1244, and a communication interface 1245. The microprocessor 12 can be configured to receive, and/or generate, and/or process data/signals to achieve the functionality of the handheld controller 120.

The microprocessor 1241 may include any suitable type of microprocessor, digital signal processor or microcontroller with general purpose or special purpose. The memory 1242 can include any suitable type of memory having mass storage for storing any type of information on which the processor may need to process. The memory 1242 can be volatile or nonvolatile, magnetic, semiconductor, magnetic, optical, erasable, non-erasable or other type of storage device or tangible (i.e., non-transitory) computer readable medium. The memory can include but not limited to ROM, flash memory, dynamic RAM and static RAM. The memory can be configured to store one or more programs for positioning and tracking the exemplary objects that can be executed by processor and disclosed in the present disclosure.

The I/O interface 1243 can be configured to facilitate a communication between the microprocessor 1241 and the input device 1210, for example, the microprocessor 1241 can be configured to receive the input data from the input device 1210 via the I/O interface 1243 in response to the input operation of user. The control interface 1244 can be configured to facilitate a communication between the microprocessor 1241 and the imaging device 140. The communication interface 1245 can be configured to facilitate a communication between the handheld controller 120 and other components of the tracking system. For example, the handheld controller 120 can communicate with the electronic device 160 via the communication interface 1245 via a network.

The microcontroller 124 can be disposed on the handle 121 or the support 122. The input device 1210 of the handle 121 can be configured to transmit the input data to the microprocessor 1241 via the I/O interface 1243 for further processing, for example, input device 1210 can be configured to generate the input data in response to the input operation of user on a button and transmit the input data to the microprocessor 1241. In some embodiments, the microprocessor 1241 can be configured to receive and transmit the input data from the input device 1210 to the electronic device 160 via the communication interface 1245 for further processing.

Furthermore, the handheld controller 120 may further include a sensor 1246 for acquiring an attitude data of the handheld controller 120. The sensor 1246 may be an attitude sensor such as an inertial measurement unit (IMU). The sensor 1246 can be electrically coupled to the microprocessor 1241 to transmit the attitude data to the microprocessor 1241. The sensor 1246 can be disposed on the handle 121 or can be disposed on the support 122.

A tracking method based on the handheld controller 120 will be described below in conjunction with the structure of the handheld controller 120. The tracking method can be applied to the tracking and positioning system illustrated in FIG. 1. As illustrated in FIG. 14, the method may begin at block S110;

At block S110, an image of the identification pattern of the exterior surface of the handle can be captured.

In some embodiments, the imaging device 140 can be configured to capture images continuously. Additionally, or alternatively, an image capturing process may be activated by a predetermined event or data/signals from the electronic device 160 or the handheld controller 120. For example, user can activate the image capturing process by operating on the input device 1210 of the handheld controller 120. The handheld controller 120 can be configured to transmit a signal for activating the imaging device to capture one or more images based on an input operation of user. Alternatively, the handheld controller 120 can be configured to transmit the input data to the electronic device 160. The electronic device 160 can be configured to activate the imaging device 140 to capture one or more images.

In some game events, the image capturing process may be activated by the imaging device 140. Additionally, or alternatively, the imaging device 140 may include a sensor for detecting an internal object within the FOV of the imaging device 140. For example, the sensor can be an ultrasonic sensor configured to detect one or more objects in the FOV of the imaging device 140. In the present embodiment, the imaging device 140 can be activated to capture one or more images when an object is detected.

In some embodiments, the imaging device 140 may be further configured to obtain depth information of the image. The depth information can be configured to indicate a location of the object. The imaging device 140 can be further configured to determine a position thereof via a position sensor thereof. In some embodiments, the imaging device 140 can be configured to capture color or black and white images. In some embodiments, the imaging device 140 can optionally process the image to obtain a processed image and transmit the processed image to electronic device 160. For example, the imaging device 140 can be configured to resize, denoise, and/or sharpen the image. The imaging device 140 can be further configured to increase/decrease contract contrast and/or brightness of the image.

In some embodiments, the imaging device 140 can be configured to receive parameters from the electronic device 160 for capturing the images. Exemplary parameters therein for capturing the image may include: a time of exposure, aperture, image resolution/size, FOV (e.g., zooming in and out), and/or color space of the image (e.g., color mode or black and white mode) and/or parameters configured to perform other types of known functions of the imaging device or a camera.

At block S120, the handheld controller can be positioned and tracked based on the identification pattern.

In some embodiments, the imaging device 140 may transmit the identification pattern to the electronic device 160 via the network, or may transmit the identification pattern to the electronic device 160 via a signal circuit. The imaging device 140 may store the identification pattern before transmitting the identification pattern to the electronic device 160.

In some embodiments, electronic device 160 can selectively process images from the imaging device 140, to increase an efficiency of processing. For example, the electronic device 160 can be configured to convert a color image to a black and white image, and/or resize the image to reduce a data size that needs to be further processed in the tracking method. Additionally, or alternatively, the electronic device 160 can be configured to reduce a noise in the image, and/or sharpened the image, and/or increased (or decreased) a contract and/or brightness of the image, such that the feature points in the identification pattern may be more easily detected. In some embodiments, other types of image processing techniques can be employed by the imaging device 140.

The electronic device 160 can be configured to determine a position and an orientation of a specific point (e.g., a center point) of the handheld controller 120 relative to the imaging device 140 by identifying the feature points of the identification pattern and based on a three-dimensional (3D) structure information of the feature points. The electrical terminal 160 can be configured to encode the feature points to greatly improve a reliability and an efficiency of the tracking method. A method or an algorithm for determining the position and the orientation of the handheld controller 120 may include an existing computer vision positioning method or algorithm, or may combine other sensors of the handheld controller 120 to accelerate the procedure and improve positioning precision. For example, the handheld controller 120 can employed the sensor 126 for collecting the attitude data to procedure and improve positioning precision.

In summary in accordance with the embodiments of the present disclosure, the handheld controller can be provided with the identification pattern. Such that the tracking and positioning the handheld controller can be realized. Thereby a handheld controller with a light source can be replaced, which avoids providing the light source and avoids controlling a frequency of the light source. Such that a structure of the handheld controller can be simplified, and costs can be reduced. In addition, there is no need to adjust parameters of the imaging device to track the controller with the light source, and an operation for controlling the imaging device can be simplified.

In the embodiments provided in the present disclosure, it should be understood that the disclosed method may also be achieved in other manners. The embodiments described above are merely illustrative. For example, the flowcharts and function blocks in the drawings illustrate the architecture, functionality, and operation of possible implementations of methods and computer program products according to embodiments of the present disclosure. Each block of the flowchart or function blocks can represent a module, a program segment, or a portion of code that can include one or more of executable instructions for performing a preset function. It should also be noted that, in some alternative embodiments, the functions noted in the blocks may also achieved in a different order than those illustrated in the drawings. For example, two consecutive blocks may be executed substantially simultaneously, and they may sometimes be executed in a reverse order relative to those illustrated in the drawings, which is depended upon a functionality involved. It is also noted that each block of the function blocks and/or the flowcharts, and any combinations of the blocks in the function blocks and/or the flowcharts, can be implemented in a dedicated hardware-based system that performs the specified function or function. Or it can be implemented by a combination of dedicated hardware and computer instructions.

In addition, each of the functional units in each embodiment of the present disclosure may be integrated into one processing unit or processor, or each of the functional units may exist physically and separately, or two or more functional units may be integrated into one unit or processor. The above integrated unit or processor can be implemented in the form of hardware or in the form of a software functional unit.

The integrated unit, if implemented in the form of a software functional unit and hardware or configured as a standalone product, may be stored in a computer readable storage medium. Based on such understanding, the technical solution of the present disclosure, in essence or in part, or all of or part of the technical solution may be embodied in the form of a software product stored in a storage medium. A number of instructions are included to enable a computer device (which may be a personal computer, server, or network device, etc.) to perform all the or part of the blocks of the methods described in various embodiments of the present disclosure. The foregoing storage medium may include: a U disk, a mobile hard disk, a read-only memory (ROM), a random-access memory (RAM), a magnetic disk, or an optical disk, and the like, which can store program code. In some embodiments, the storage medium or the memory can be disposed in an electronic device, or can be integrated with the electronic device. Such that the electronic device can be configured to store the program code.

The words “first”, “second”, “third”, “fourth”, etc. (if present) in the specification and claims of the present disclosure and the above figures are configured to distinguish similar objects but not to describe a specific order. It is to be understood that the data so configured may be interchanged where appropriate, so that the embodiments described herein can be implemented in a sequence other than what is illustrated or described herein. In addition, the words “comprise” and “include” are intended to cover a non-exclusive inclusion, for example, a process, method, system, product, or device that includes a series of steps or units is not necessarily limited to those steps or units may include other steps or units not explicitly listed or inherent to such processes, methods, products or devices.

The above embodiments are only configured to illustrate the technical solutions of the present disclosure, and are not intended to be limiting. Although the present disclosure has been described in detail with reference to the foregoing embodiments, those skilled in the art will understand that the technical solutions described in the embodiments may be modified, or the equivalents of the technical features may be replaced by the equivalents of the technical solutions of the embodiments of the present disclosure.

The above is only the specific embodiment of the present disclosure, but the scope of the present disclosure is not limited thereto. Any person skilled in the art can easily think of changes or substitutions within the technical scope of the present disclosure. It should be covered by the scope of the present disclosure. Therefore, the scope of the disclosure should be determined by the scope of the claims.

1. A handheld controller, comprising:
a handle having an input device for detecting an input operation of a user;
a support coupled to the handle; wherein the support having an exterior surface, and an identification pattern disposed on the exterior surface.

2. The handheld controller as claimed in claim 1, wherein the support is annular.

3. The handheld controller as claimed in claim 2, wherein the handle comprises a first end and a second end opposite to the first end, the first end is coupled to the support, and the second end is far away from the support.

4. The handheld controller as claimed in claim 3, wherein the input device is disposed at the second end, the handle is configured to detect the input operation via the input device when a hand of user passes through the support and holds the handle.

5. The handheld controller as claimed in claim 4, wherein the handle is inclined relative to a plane on which the support is disposed.

6. The handheld controller as claimed in claim 4, wherein the support further comprises an interior surface; the handle is disposed in a space defined by the interior surface.

7. The handheld controller as claimed in claim 3, wherein the input device is disposed at the first end, the handle is configured to detect the input operation via the input device when a hand of user is outside the support and holds the handle.

8. The handheld controller as claimed in claim 2, wherein the support defines an opening, the handle is coupled to an end of the support adjacent to the opening, the handle is configured to detect the input operation via the input device when a hand of user passes the opening and holds the handle.

9. The handheld controller as claimed in claim 2, wherein the exterior surface of the support comprises a first surface and a second surface, the first surface and the second surface intersect with each other at a circumscribed circle of the support, the identification pattern is disposed on at least one of the first surface and the second surface.

10. The handheld controller as claimed in claim 9, wherein the identification pattern is disposed on both of the first surface and the second surface, the identification pattern on the first surface and the identification pattern on the second surface are different from each other.

11. The handheld controller as claimed in claim 2, wherein the exterior surface is an arc surface; the identification pattern is disposed on the arc surface.

12. The handheld controller as claimed in claim 2, wherein the exterior surface comprises a plurality of plates in different shapes, and the plates are spliced together to form the exterior surface; each of the plates provides a pattern thereon; patterns of all the plates corporately form the identification pattern.

13. (canceled)

14. The handheld controller as claimed in any one of claims 1 to 13, wherein the identification pattern comprises a background and a feature point distributed on the background; brightness of the background and brightness of the feature point are different so that an imaging device is capable of distinguishing the background and the feature point.

15. The handheld controller as claimed in claim 14, wherein all the feature points have the same size and all the feature points are evenly distributed on the background.

16. The handheld controller as claimed in claim 14, wherein the feature points comprise a plurality of first feature points and a plurality of second feature points; the first feature points are larger than the second feature points; the first feature points and the second feature points are distributed on the background alternately.

17. (canceled)

18. The handheld controller as claimed in claim 14, wherein the background is black, and the feature point is white; or
the background is white, and the feature point is black.

19. (canceled)

20. A tracking system, comprising:
an electronic device;
an imaging device; and
a handheld controller having:
a handle having an input device for detecting an input operation of a user;
a support coupled to the handle; the support comprising an exterior surface and
an identification pattern disposed on the exterior surface;
wherein the imaging device is configured to identify the identification pattern.

21. A tracking method applied in a tracking system; the tracking system comprising an electronic device, an imaging device, and a handheld controller, the handheld controller comprising a handle and a support coupled to the handle; the handle comprising an input device for detecting an input operation of a user; an exterior surface of the support has an identification pattern; and the method comprising:
capturing an image of the identification pattern via the imaging device;
positioning and tracking the handheld controller via the electronic device based on the identification pattern.

22. The method as claimed in claim 21, wherein the handheld controller comprises a sensor for detecting an attitude data; positioning and tracking the handheld controller based on the identification pattern via the electronic device, comprises:
positioning and tracking the handheld controller via the electronic device based on the identification pattern and the attitude data obtained by the sensor.

23. The method as claimed in claim 21, wherein positioning and tracking the handheld controller based on the identification pattern via the electronic device, comprises:
determining a position and an orientation of a specific point of the handheld controller relative to the imaging device by identifying feature points of the identification pattern and based on a three-dimensional (3D) structure information of the feature points; and
positioning and tracking the handheld controller via the electronic device based on the position and the orientation.
